(19) United States
(12) Patent Application Publication
(10) Pub. No.: US 2010/0209095 A1
(43) Pub. Date: Aug. 19, 2010

(54) MULTIFUNCTIONAL DEVICE SUPPORT AND TRANSPORT APPARATUS

(76) Inventor: ALEXANDER P. DeSORBO, Woodbury, CT (US)

Correspondence Address: MCCORMICK, PAULDING & HUBER LLP, CITY PLACE II, 185 ASYLUM STREET, HARTFORD, CT, 06103, US

(21) Appl. No.: 12/708,001

(22) Filed: Feb. 18, 2010

Related U.S. Application Data
(60) Provisional application No. 61/153,448, filed on Feb. 18, 2009.

(51) Int. Cl. G03B 17/00; B62B 3/02

(52) U.S. Cl. 396/428; 280/651; 396/419

(57) ABSTRACT

A multi-functional device and transport apparatus that includes a telescoping spine mechanism. The device further includes a selectively extendable axle mechanism that is operatively secured to the spine mechanism. A plurality of wheels are rotatably secured to the axle mechanism. The axle mechanism may be selectively extended to effectively increase a width of the multi-function device and transport apparatus to stabilize the apparatus.

### CROSS REFERENCE TO RELATED APPLICATIONS

This application claims the benefit of U.S. Provisional Patent Application No. 61/153,448 filed on Feb. 18, 2009, which is hereby incorporated by reference in its entirety.

### FIELD OF THE INVENTION

The present invention relates generally to a multifunctional device and transport apparatus, and more particularly to a multifunctional device and transport apparatus for the transportation, support and storage of image capturing and/or recording devices and related accessories.

### BACKGROUND OF THE INVENTION

In the photographic, motion picture and video fields, it is well known to package cameras, lighting equipment and their associated accessories in travel bags. These bags are often wheeled or they may be placed on wheeled carts in order to facilitate their movement from place to place. Additionally, support stands such as tripods, monopods, lighting stands or similar constructs are oftentimes necessary to the operation of the cameras or lighting equipment. The supports are typically packaged for transport in a similar fashion—in bags, wheeled cases or on carts. The burden of the number of cases required for this equipment has led to numerous attempts to combine their functions.

Historically, this effort has been limited for two reasons. First, the volume and weight of the separate elements—camera and camera support, for example—has been such that for an individual to handle them in transport they could not be combined. Second, the weight of the camera or lighting gear was such that a lightweight camera support could not stabilize the camera or lighting in a manner that would allow for an acceptable level of operation.

Thus, the very nature of the technically improved smaller and lighter camera/devices, allows for smaller lighter camera supports. However, a lighter support is undesirable as a certain mass is required to adequately support and counter-balance a camera during operation.

With the forgoing problems and concerns in mind, it is the general object of the present invention to provide a multifunctional device and transport apparatus for the transportation, support and storage of image capturing and/or recording devices and related accessories.

### SUMMARY OF THE INVENTION

It is one object of the present invention to provide a multifunctional device and transport apparatus.

It is another object of the present invention to provide a multifunctional device and transport apparatus for the transportation, support and storage of image capturing and/or recording devices and related accessories.

It is another object of the present invention to provide a multifunctional device and transport apparatus in which a deployable frame assembly is integrated with a transport case and support assembly.

It is another object of the present invention to provide a multifunctional device and transport apparatus in which the deployable frame assembly includes a expandable wheel base.

An embodiment of the present invention is a multi-functional device and transport apparatus that includes a telescoping spine mechanism. The device further includes a selectively extendable axle mechanism that is operatively secured to the spine mechanism. A plurality of wheels are rotatably secured to the axle mechanism. The axle mechanism may be selectively extended axially to effectively increase a width of the multi-function device and transport apparatus to stabilize the apparatus.

An additional embodiment of the present invention is a transportable image capture apparatus that includes an image capture device operatively connected to an extendable spine. The apparatus also includes a selectively extendable axle mechanism operatively secured to the spine. A plurality of wheels are rotatably secured to opposing distal ends of the axle mechanism. The plurality of wheels include a braking mechanism to selectively limit their rotation. The apparatus further includes a leg that may be pivotally extended from the spine to further support the apparatus. The axle mechanism may be selectively extended axially to effectively increase a width of the apparatus thereby stabilizing the apparatus.

These and other objectives of the present invention, and their preferred embodiments, shall become clear by consideration of the specification, claims and drawings taken as a whole.

### BRIEF DESCRIPTION OF THE DRAWINGS

FIG. 1 is a perspective view of a deployable frame assembly, according to one embodiment of the present invention.

FIG. 2 illustrates a multifunctional device and transport apparatus as integrated with the deployable frame assembly of FIG. 1, also according to one embodiment of the present invention.

FIGS. 3-7 illustrate the transformation of the multifunctional device and transport apparatus shown in FIG. 2 from its preferred transport state, to its preferred partially deployed state.

FIGS. 8 and 9 illustrate the wheel locking mechanism of the multifunctional device and transport apparatus shown in FIG. 2.

FIGS. 10-14 illustrate the utilization of the telescoping spine mechanism, as integrated with the multifunctional device and transport apparatus shown in FIG. 2.

FIGS. 15-17 illustrate the mounting of an image recording apparatus to the multifunctional device and transport apparatus shown in FIG. 2.

FIG. 18 illustrates one possible deployment and use of the multifunctional device and transport apparatus shown in FIG. 2.

### DETAILED DESCRIPTION OF THE PREFERRED EMBODIMENT

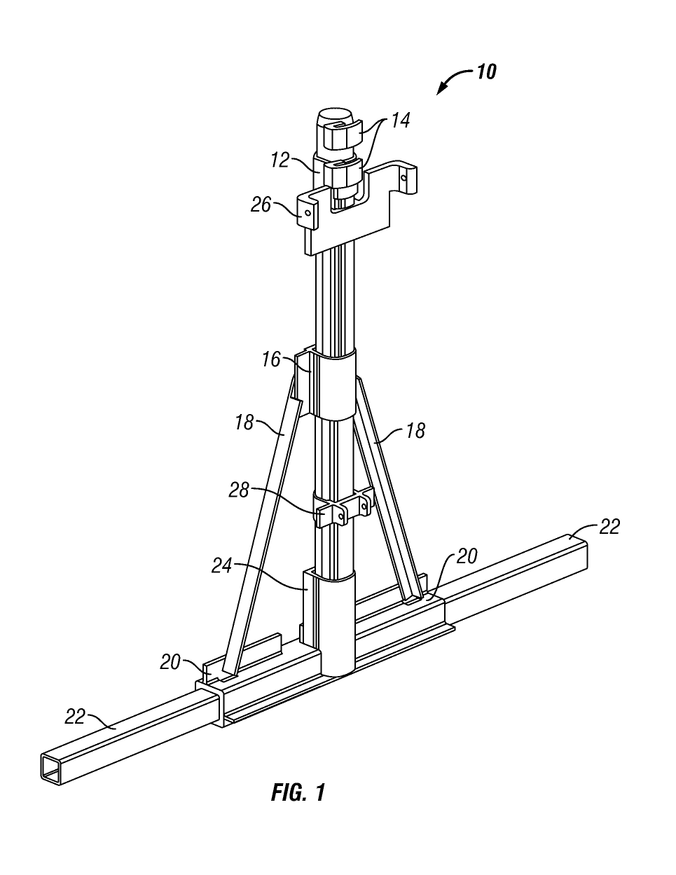

FIG. 1 is a perspective view of deployable frame assembly 10, as integrated with the multifunctional device and transport apparatus according to one embodiment of the present invention. As shown in FIG. 1, the deployable frame assembly 10 includes a telescoping spine mechanism 12 which is preferably formed as a nested tubular structure crafted from any rigid or semi-rigid material, such as but not limited to steel, aluminum, ceramics, carbon fiber, or the like. The spine mechanism 12 is preferably built onto a padded and compartmented case, which is capable of housing an image capturing and/or recording device and any number of peripheral accessories.

While a nested tubular structure has been described, it will be readily appreciated that the nested, telescoping elements of the spine mechanism 12 may evidence any cross-sectional configuration, such as but not limited to a rectangular, or square cross section, without departing from the broader aspects of the present invention.

Returning to FIG. 1, a pair of tension collars 14 are formed adjacent the upper distal end of the spine mechanism 12. As will be appreciated, the selective operation of one or both of the tension collars 14 will permit one or more of the nested telescoping tubes to become fixedly extended a predetermined amount so as to position articles mounted atop thereof to be utilized by an operator, as will be described in more detail later.

A brace attachment 16 is secured to the spine mechanism 12 and provides an anchoring location for a pair of bracing legs 18. For their part, the bracing legs 18 are affixed to a stationary axle 20 within which a pair of opposing movable axles 22 are nested for selective extension therefrom. An axle attachment 24 is provided to secure the lower portion of the spine mechanism 12, while a leg attachment plate 26 is position farther up the spine mechanism 12. The leg attachment plate 26 is utilized in those embodiments in which a third stabilizing leg is provided, as shown in more detail later. A spreader attachment collar 28 is also disposed on the spine mechanism 12.

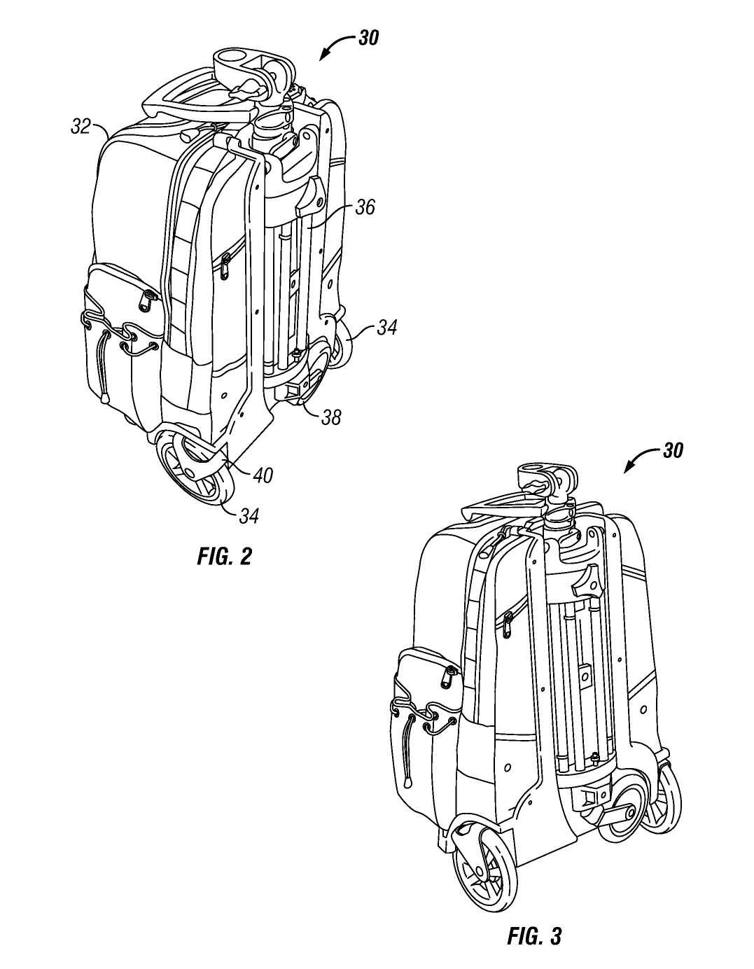

Turning now to FIG. 2, a multifunctional device and transport apparatus 30 is shown, incorporating the deployable frame assembly 10 according to one embodiment of the present invention. As shown in FIG. 2, a padded case 32 is supported upon the deployable frame assembly 10, including having a pair of wheels 34 operatively connected to the opposing distal ends of the movable axles 22.

It will be readily appreciated that the padded case 32 is capable of supporting a plurality of various batteries, lights, film and related image recording accessories useful in the field of image capturing and recording. Further, the present invention is obviously not limited in the nature of the accessories carried within the padded case 32, which may or may not be related to the field of image capturing and recording.

A selectively deployable third leg assembly 36 is also shown in FIG. 2, and is pivotally connected to the leg attachment plate 26. The third leg assembly 36 further includes a collapsible wheel 38, which is typically folded against the body of the padded case 32 during transport, but can be extended when the third leg assembly 36 is itself deployed, as will be shown more clearly in connection with FIGS. 5-7. Integrated wheel locks 40 are also shown as being mounted to the wheels 34, and may be rotated about the axis of the wheels 34, to slightly lift, and therefore lock, the wheels 34 against any rotation, when desired.

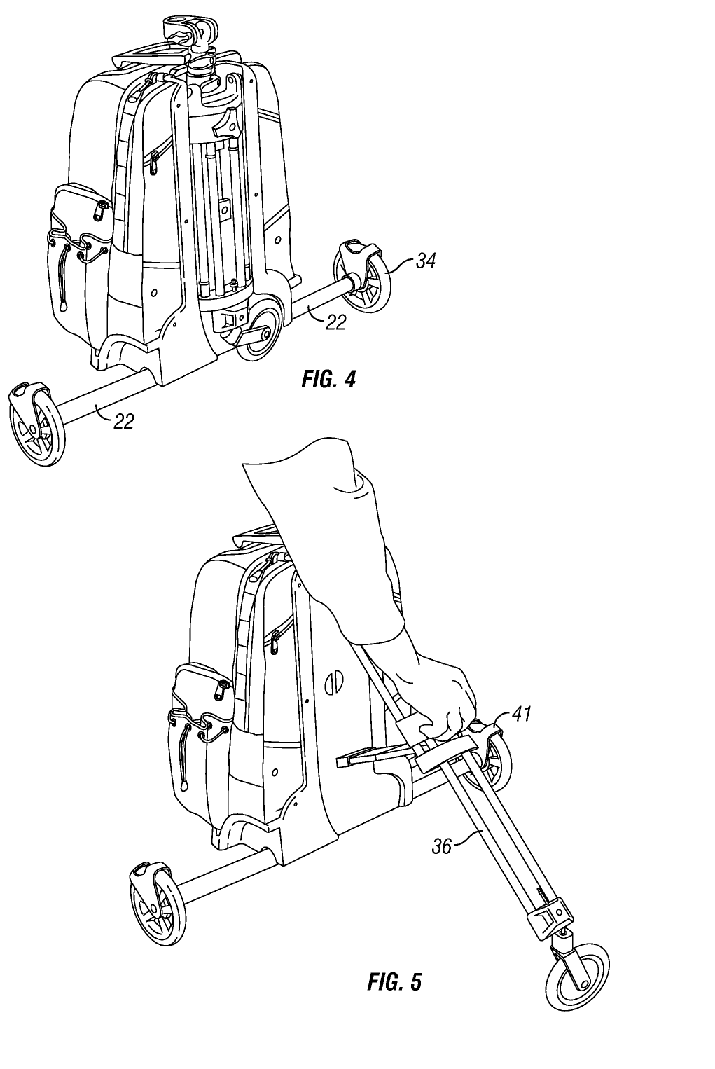

FIGS. 3-7 illustrate the transformation of the multifunctional device and transport apparatus 30 from its preferred transport state (shown in FIG. 3), to its partially deployed state (as shown in FIG. 7). As shown in FIG. 4, the wheels 34 are first extended in an axial direction, via operation of the movable axles 22, so as to increase the effective width of the multifunctional device and transport apparatus 30.

It is therefore one important aspect of the present invention that the wheels 34 of the multifunctional device and transport apparatus 30 be as compact as possible during the preferred transport configuration, as shown in FIG. 3, but also be capable of selectively extending in an axial direction, thereby (in part) increasing the stability of the multifunctional device and transport apparatus 30.

FIG. 5 illustrates the deployment of the third leg assembly 36 from its folded and retracted position (best shown in FIGS. 2 and 3). As shown in FIG. 5, once the third leg assembly 36 has been pivoted from the leg attachment plate 26, an extension lever 41 may be actuated to cause a telescoping extension of the collapsible wheel 38. The extension lever 41 can thereafter be locked, thus maintaining the extension of the third leg assembly 36.

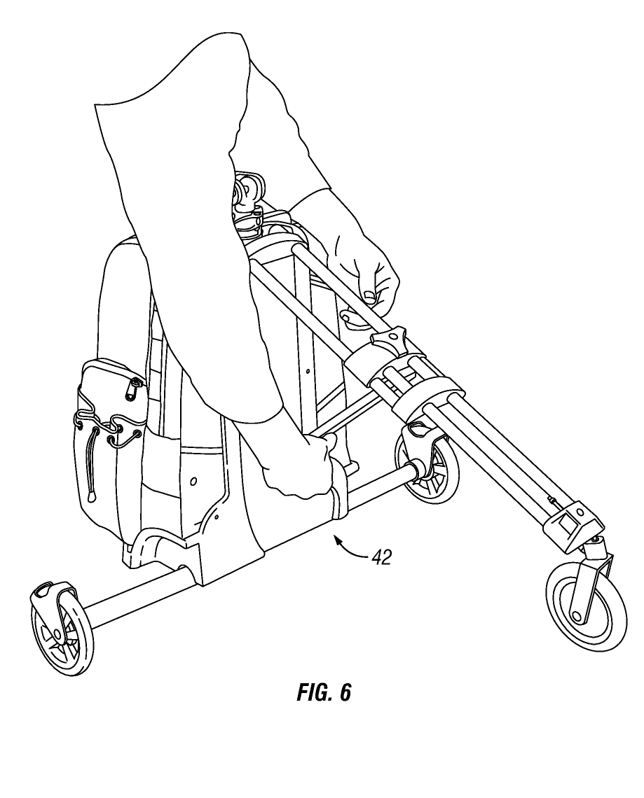

FIG. 6 illustrates the manipulation of a rigid leg support 42, thereby adding a measure of rigidity and strength to the now-extended third leg assembly 36. FIG. 7 shows the multifunctional device and transport apparatus 30 in its partially deployed state, whereby the expanded base formed by the axially extended wheels 34 and the (now-extended) collapsible wheel 38 can be easily appreciated.

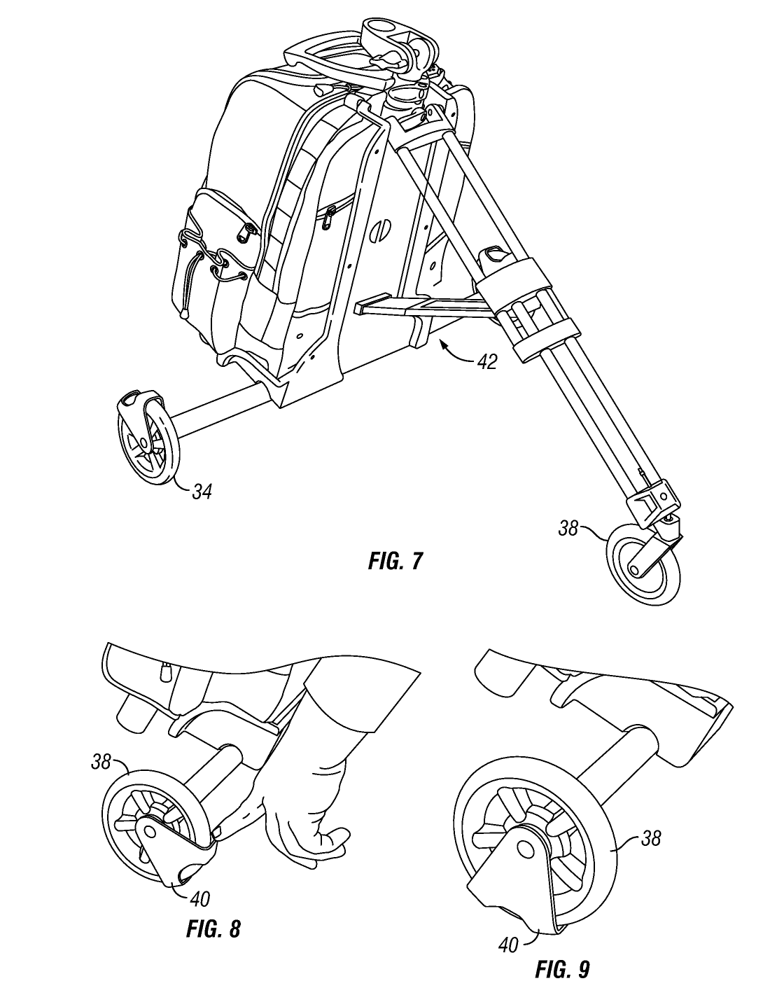

Further stabilization of the multifunctional device and transport apparatus 30 can be effectuated through the rotation of the integrated wheel locks 40, as shown in FIG. 8. As best seen in FIG. 9, once the integrated wheel locks 40 have been rotated beneath the wheels 38, the wheels 38 are prevented from further rotation about their axis, and the multifunctional device and transport apparatus 30 is secured against sliding and/or rolling movement.

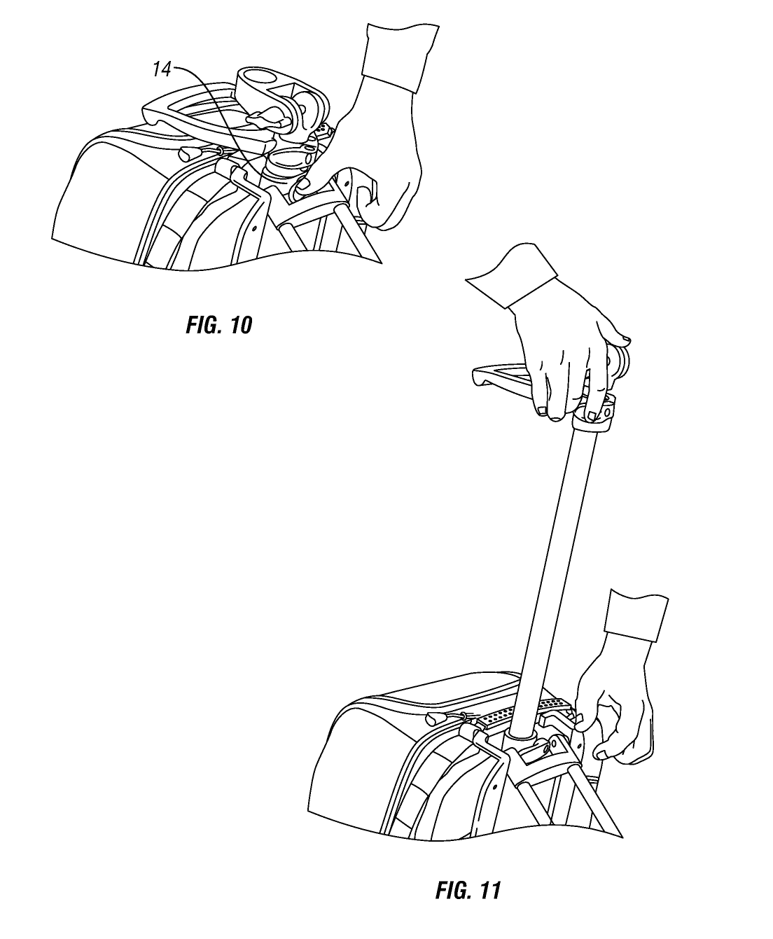

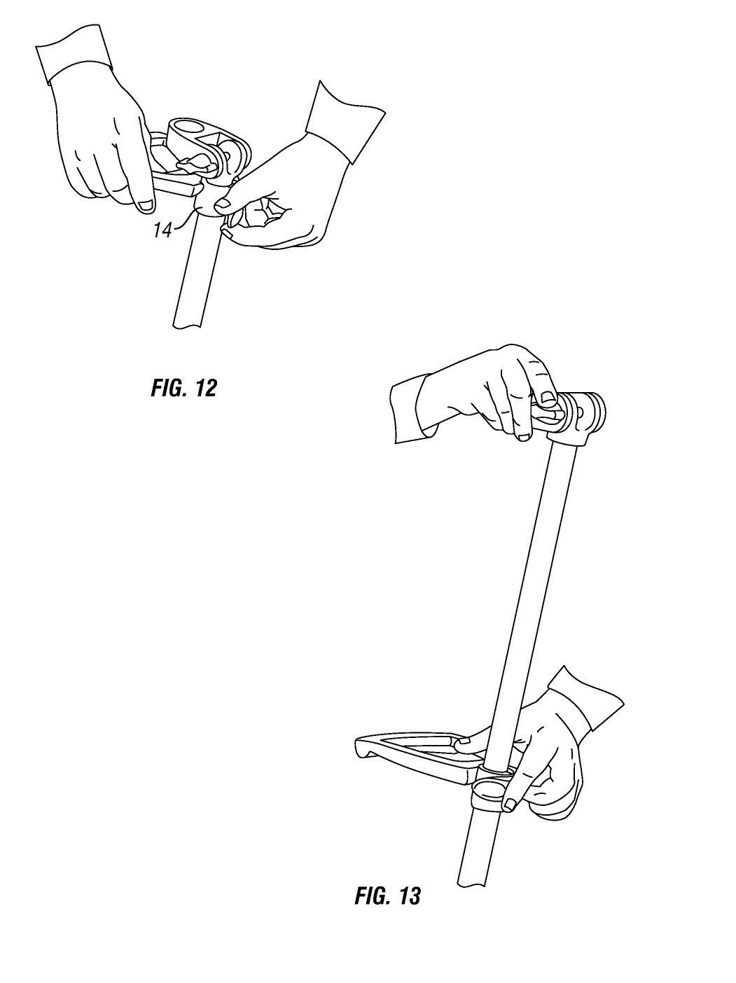

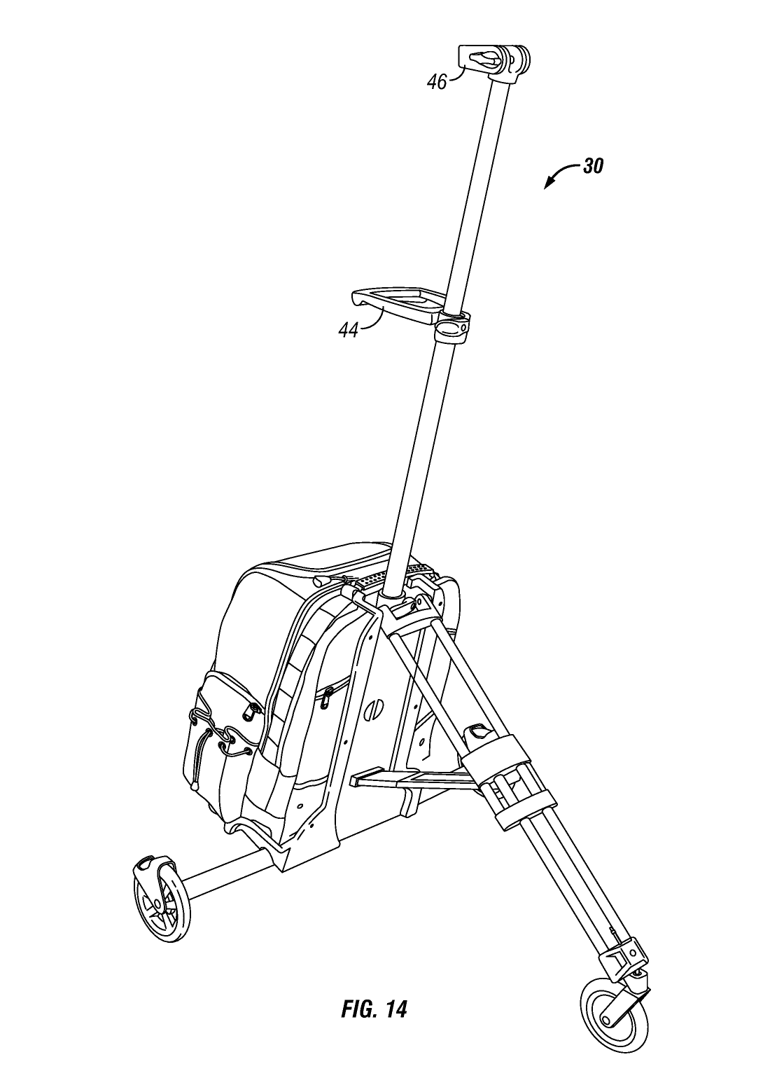

FIGS. 10-14 illustrate more clearly the utilization of the telescoping spine mechanism 12, in accordance with one embodiment of the present invention. As shown in FIGS. 10 and 11, the lower of the two tension collars 14 may be actuated (and subsequently re-locked) so as to permit one of the nested telescoping tubes to be extended upwardly in a fixed orientation. FIGS. 12 and 13 illustrate the operation (and subsequent re-locking) of the upper of the two tensioning collars 14, thereby extending a second nested and telescoping tube still further in the upward direction, also in a fixed orientation. FIG. 14 illustrates the final deployed state of the multifunctional device and transport apparatus 30.

While two tensioning collars have been described in connection with the spine mechanism 12, the present invention is not so limited in this regard as any number of tensioning collars, or similar structures, may be provided to the spine mechanism 12 in order to effectuate the selective extension of one or more telescoping tubes. Moreover, as also shown in FIG. 14, the tensioning collars 14 may, or may not, be selectively combined with a handle 44, or the like, in order to assist in the active transportation of the multifunctional device and transport apparatus 30, in either its retracted or final deployed state.

Also of note in FIG. 14 is the presence of a mounting assembly 46, which again may, or may not, be integral with one of the two tensioning collars 14. The mounting assembly 46 is utilized to secure an image capturing and/or recording device to the upper distal end of the now-extended telescoping tubes of the spine mechanism 12.

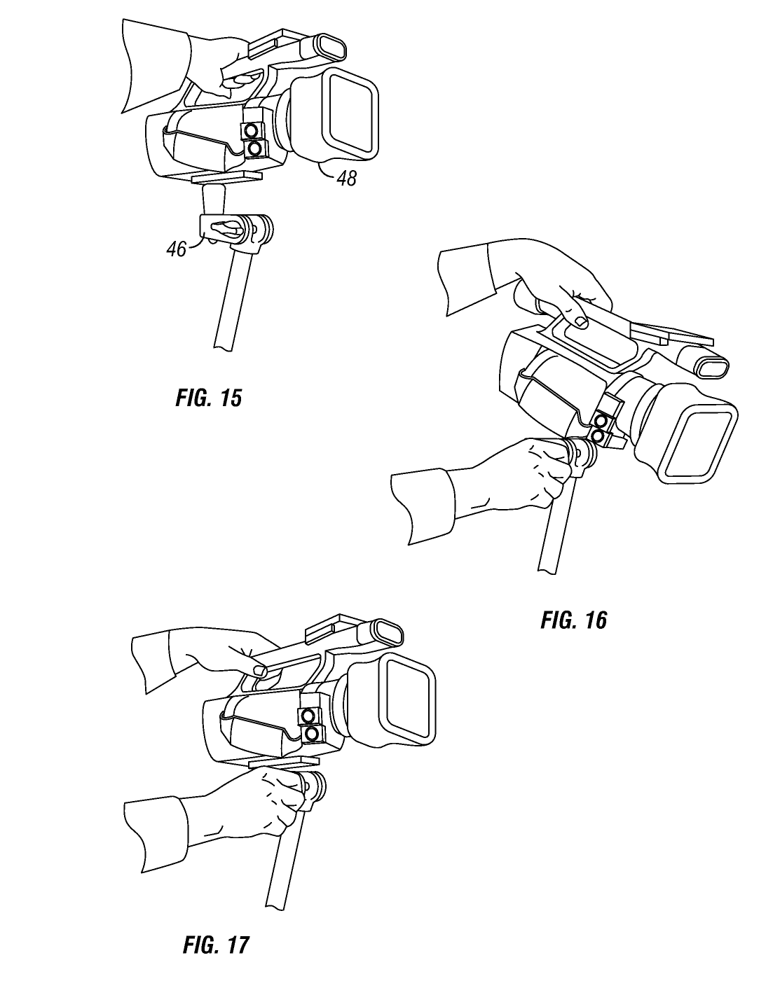

FIGS. 15-17 best illustrate an image capturing and/or recording device 48 affixed to the mounting assembly 46. FIG. 16 in particular shows that the mounting assembly 46 is capable of being set (and re-set, as in FIG. 17) to any desired angle of inclination while the image capturing and/or recording device 48 is affixed atop the telescoping tubes of the spine mechanism 12.

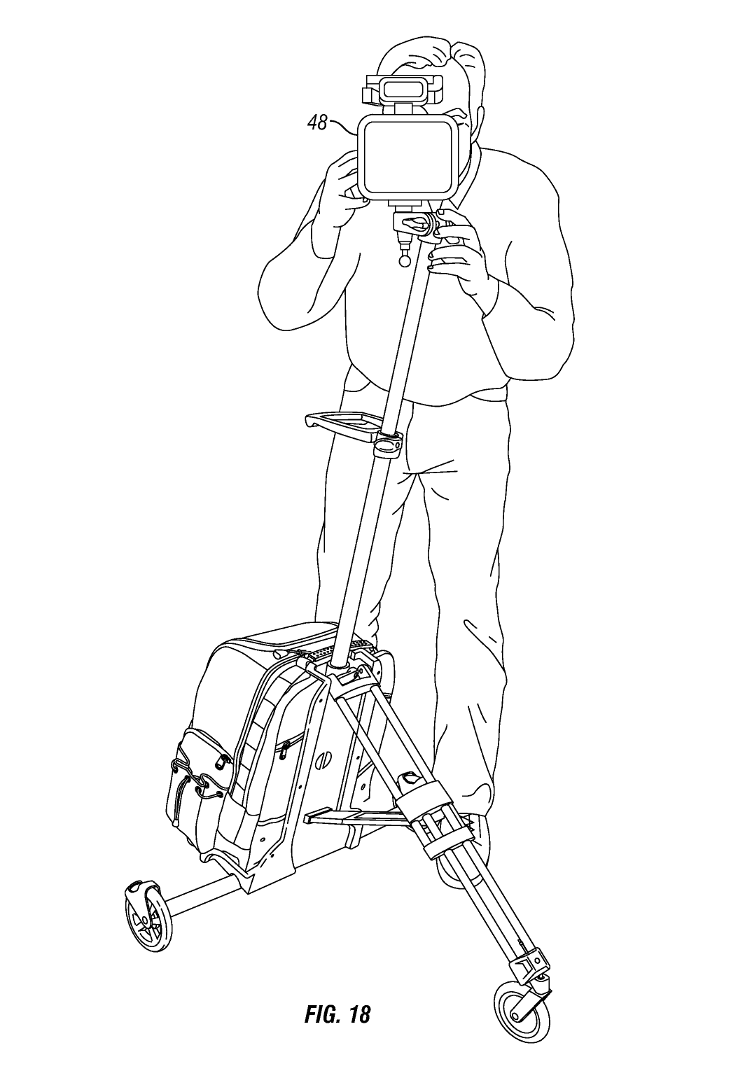

It will therefore be readily appreciated that, once fully deployed, the multifunctional device and transport apparatus 30 provides a stable platform upon which the image capturing and/or recording device 48 may be affixed. Moreover, the integration of the padded case 32 with the deployable frame assembly 10 provides an effective counter-weight to any image capturing and/or recording device mounted atop the spine mechanism 12. FIG. 18 most clearly illustrates one possible deployment of the multifunctional device and transport apparatus 30, as it supports the image capturing and/or recording device 48 for use by the operator.

It will therefore be readily appreciated that the upper portion of the telescoping spine mechanism 12 includes a structure to orient and mount an image capturing and/or recording device, or any other electronic display, equipment or assembly. Indeed, the mounting assembly 46 may instead support a lighting mechanism or assembly, a worktable for laptop computers, or the like, a telescope or other sight-finding implement, a still camera, or any other construct or assembly capable of being supported by the multifunctional device and transport apparatus 30, without departing from the broader aspects of the present invention.

As discussed previously, the multifunctional device and transport apparatus 30 can include an integral mechanism (i.e., the mounting assembly 46, or the like) for the user to control the horizontal and vertical movement of the image capturing and/or recording device 48, or alternatively, can accept any number of commercially available pan and tilt mechanisms well known in the field. The telescoping aspect of the spine mechanism 12 can then be adjustably extended to increase the operating height of the camera/device to a desired level.

Thus, the multifunctional device and transport apparatus 30 of the present invention is therefore capable of providing:
Axially retractable wheels extending laterally from the case;
Brake or lift mechanisms which limit the wheel movement thus further stabilizing the structure;
A retractable, extendable third leg member which may be deployed, as needed;
A wheel structure for the third leg which can be engaged or disengaged for mobility or further stability;
A retractable, telescoping column for adjusting the height of the camera/device; and
A transport case which provides a ballast for any device or equipment affixed to the top thereof.

As will be appreciated by one of ordinary skill, the multifunctional device and transport apparatus 30 of the present invention has the ability to use the deployable frame assembly 10 in a variety of positions: with the telescoping spine assembly 12 in its extended or retracted position; with the third leg assembly and collapsible wheel being selectively retracted/extended; and/or by extending the operational base of the multifunctional device and transport apparatus 30 by axially extending the wheels mounted to the movable axles.

It will also be readily appreciated that the multifunctional device and transport apparatus 30 therefore serves to improve the security of valuable equipment by encapsulating all aspects in a single package that can always be under the operator's control, as well as providing improved convenience and improved quality of images from the deployment of a stable support platform versus handheld operation.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A multi-functional device and transport apparatus, said apparatus comprising:
a telescoping spine mechanism;
a selectively extendable axle mechanism operatively secured to said spine mechanism;
a plurality of wheels rotatably secured to said axle mechanism; and
wherein said axle mechanism may be selectively extended axially to effectively increase a width of said apparatus thereby stabilizing said apparatus.

2. The multi-function device and transport apparatus of claim 1, said apparatus further comprising a leg that may be pivotally extended from said spine mechanism to further support said apparatus.

3. The multi-function device and transport apparatus of claim 2, wherein said leg includes at least one wheel.

4. The multi-function device and transport apparatus of claim 1, said apparatus further comprising a mounting assembly secured to said spine mechanism.

5. The multi-function device and transport apparatus of claim 4 wherein said mounting assembly is configured for attachment of an image capture device.

6. The multi-function device and transport apparatus of claim 1, wherein said plurality of wheels include a braking mechanism such that said wheels may be selectively fixed in a position.

7. The multi-function device and transport apparatus of claim 1, said apparatus further comprising a case secured to spine mechanism, said case having an internal compartment.

8. A multi-functional transport apparatus, said apparatus comprising:
an extendable spine mechanism;
a selectively extendable axle mechanism operatively secured to said spine mechanism;
a plurality of wheels rotatably secured to opposing distal ends of said axle mechanism;
a leg that may be pivotally extended from said spine mechanism to further support said apparatus; and
wherein said axle mechanism may be selectively extended axially to effectively increase a width of said multi-function transport apparatus thereby stabilizing said apparatus.

9. The multi-function transport apparatus of claim 8, wherein said leg includes at least one wheel.

10. The multi-function transport apparatus of claim 8, said apparatus further comprising a mounting assembly secured to said spine mechanism, said assembly configured for attachment of an image capture device.

11. The multi-function transport apparatus of claim 8, wherein said plurality of wheels include a braking mechanism such that said wheels may be selectively fixed in a position.

12. The multi-function transport apparatus of claim 8, said apparatus further comprising a case secured to spine mechanism, said case having an internal compartment.

13. A transportable image capture apparatus, said apparatus comprising:
an image capture device operatively connected to an extendable spine;
a selectively extendable axle mechanism operatively secured to said spine;
a plurality of wheels rotatably secured to opposing distal ends of said axle mechanism, said plurality of wheels including a braking mechanism to selectively limit rotation of said wheels;
a leg that may be pivotally extended from said spine to further support said apparatus; and
wherein said axle mechanism may be selectively extended axially to effectively increase a width of said apparatus thereby stabilizing said apparatus.

14. The transportable image capture apparatus of claim 13, wherein said image capture mechanism is secured to said extendable spine through a mounting assembly.

15. The transportable image capture apparatus of claim 14 wherein said mounting assembly allows a user to control horizontal and vertical movement of said image capture device.

16. The transportable image capture apparatus of claim 14 wherein said mounting assembly allows a user to tilt and pan said image capture device.

17. The transportable image capture apparatus of claim 13, said apparatus further comprising a case secured to spine, said case having an internal storage compartment.

18. The transportable image capture apparatus of claim 13, wherein said leg includes at least one wheel.

19. The transportable image capture apparatus of claim 18, wherein said at least one wheel includes a locking mechanism which can selectively limit rotation of said at least one wheel.

20. The transportable image capture apparatus of claim 17 wherein said case includes ballast to counter-balance and support said image capture device operatively connected to said spine.
